(19) United States
(12) Patent Application Publication
(10) Pub. No.: US 2012/0120113 A1
(43) Pub. Date: May 17, 2012

(54) Method and apparatus for visualizing 2D product images integrated in a real-world environment

(76) Inventor: Eduardo Hueso, Berkeley, CA (US)

(21) Appl. No.: 12/927,401

(22) Filed: Nov. 15, 2010

(51) Int. Cl. G09G 5/00

(52) U.S. Cl. 345/672

(57) ABSTRACT

A software application, which uses a portable device and augmented reality techniques to reconstruct a 2D image of the user's environment augmented with a 2D element representing an object or product which looks like part of the environment image.

### FIELD OF THE INVENTION

The present invention relates generally to retail shopping systems, and more particularly, to methods and apparatus for assisting shoppers in making purchase decisions by visualizing products from 2D images embedded in their own physical environment.

### BACKGROUND OF THE INVENTION

Augmented reality research explores the application of computer-generated imagery in live-video streams as a way to expand the real-world.

Portable devices, e.g. mobile phones, with the necessary capabilities for executing augmented reality applications have recently become ubiquitous.

The portable devices incorporate a digital camera, a color display and a programmable unit capable of rendering 2D and 3D graphics onto the display.

The processing power of the portable devices allows for basic tracking of features from the camera's image stream.

The portable devices are often equipped with additional sensors like compass and accelerometers.

The connectivity of the portable devices allows downloading data, like 2D images and product descriptions from the Internet at almost all times.

### SUMMARY OF THE INVENTION

A software application, which uses a hand-held augmented reality device and augmented reality techniques to reconstruct a 2D image of the user's environment augmented with two-dimensional images of consumer products which appear to be part of the physical scene.

### BRIEF DESCRIPTION OF THE DRAWINGS

FIG. 1 shows a hand-held augmented reality device portable device with display and camera;

FIG. 2 shows a sequence of screens of a dynamic embodiment of the present invention as the user interacts with it;

FIG. 3 shows a 2D product image used by the system;

FIG. 4 is a flow graph of the program in a static embodiment;

FIG. 5 is a flow graph of the program in a dynamic embodiment;

FIG. 6 is a data flow graph of the program;

FIG. 7 shows a computer;

### DETAILED DESCRIPTION OF THE INVENTION

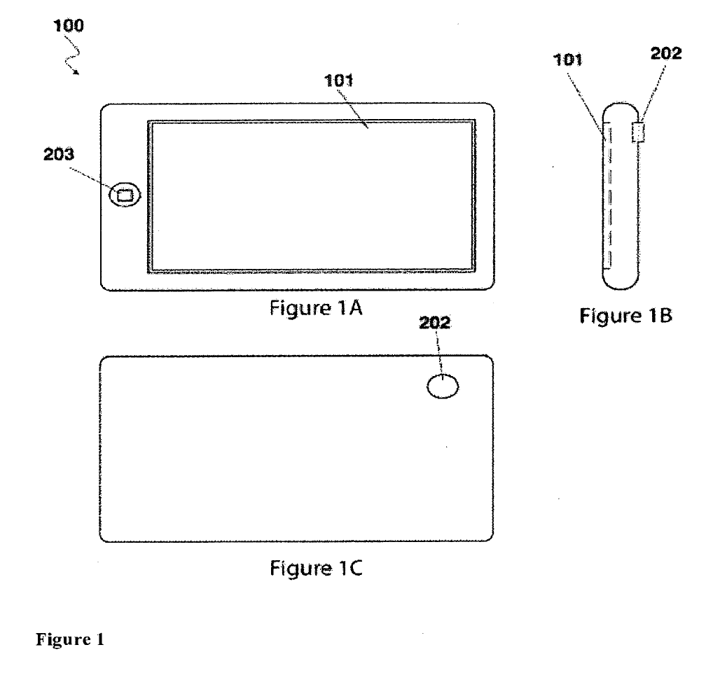

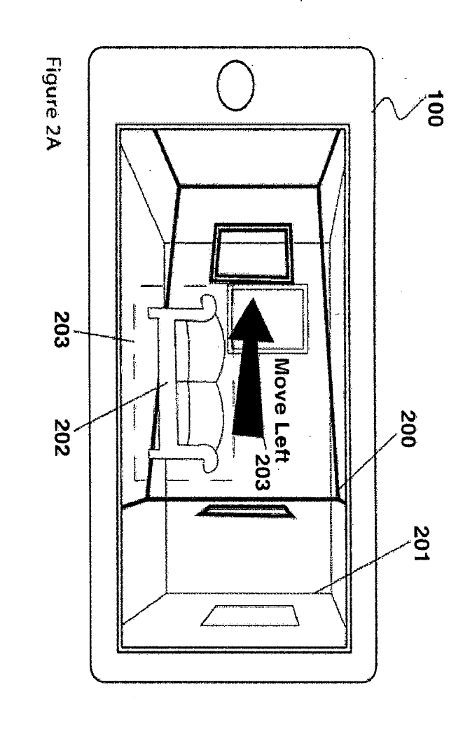

Referring now to the invention in more detail, in FIG. 1 is shown a hand-held augmented reality device 100 that would be used to run the application, which corresponds to this invention. The hand-held augmented reality device comprises a camera 102, fixed or pivoting; a display 101 which in at least one configuration of the camera points in roughly the opposite direction of the camera; a processing unit associated to the camera and the display; an optional networking unit; and an input device capable of taking user input either via a touch screen/pad, keyboard or any other mechanism. The hand-held augmented reality device might also comprise additional sensors like a compass, an accelerometer, gps, gyroscope or any other sensor that could be used to compute the devices position, orientation, velocity and/or acceleration.

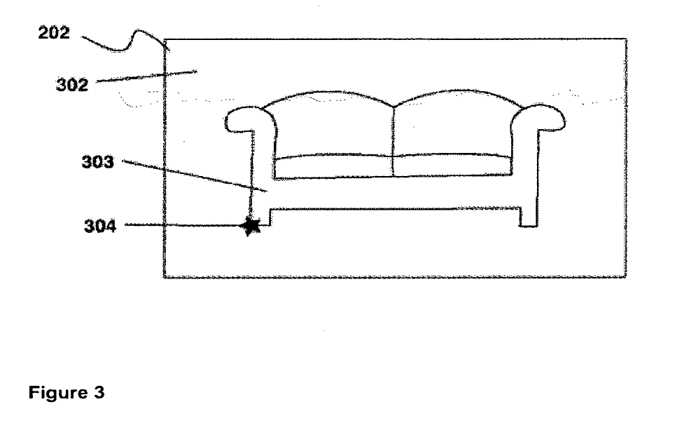

FIG. 3 shows a product image 202 used by the present invention. In this case the product selected is a sofa. The main purpose of the present invention is to synthesize an augmented image by embedding a product image 202 within an environment image 200. Once the product image 202 has been embedded in the environment image 200, it becomes an embedded product image. The embedded product image is a transformation of the product image that causes it to blend with the environment image and create the illusion of being part of the environment.

The environment image 200 is a still or a video image captured by the camera 102 of the hand-held augmented reality device 100.

Within its preferred embodiments, this invention includes a dynamic and a static embodiment.

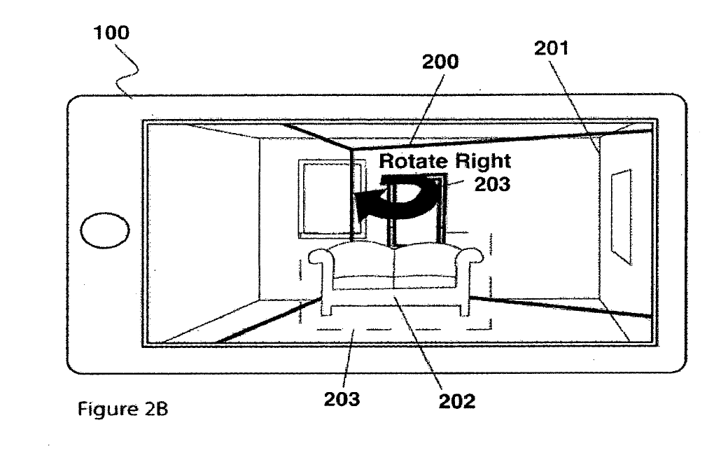

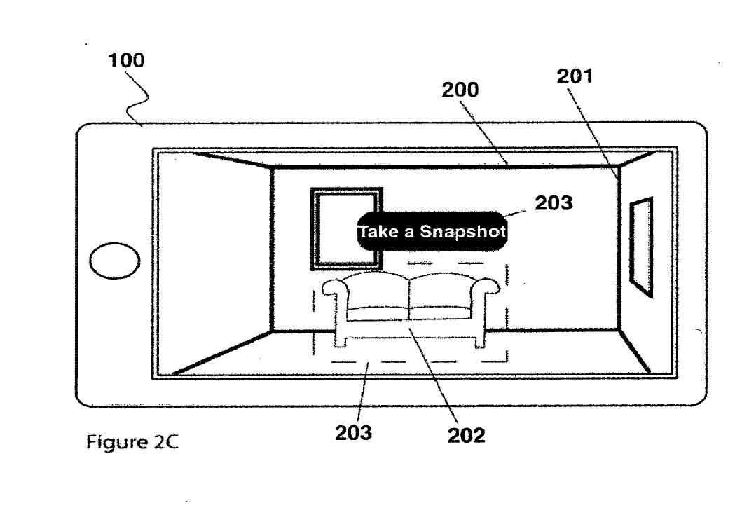

FIG. 2 shows a sequence of screens that would appear to the user as he/she interacts with the device in a dynamic embodiment of the invention.

FIG. 2A shows the device 100 displaying on screen: the environment image 200 from the device's camera 102; a three-dimensional environment model 201 rendered by the processing unit associated with the display; and an instruction icon 203 indicating to the user to rotate or move the device in some direction. In this case the instruction is to move the device towards the left hand side of the user.

The three-dimensional environment model 201 may or may not be rendered over the environment image 200 either in a wireframe mode or in a semi-transparent mode in order for the environment image 200 to show through. This way the user can visualize both the environment image and the three-dimensional environment model overlaid. In the dynamic embodiment of the present invention, the three-dimensional environment model doesn't need to be rendered as the user can go by the instructions alone. However, in the static embodiment of the invention, the visual representation of the three-dimensional environment model is what the user uses to determine the correct camera position and orientation.

The three-dimensional environment model 201 shown in FIG. 2A comprises a floor and set of walls that resemble as much as practical the environment image in the life image 200. In this case two existing windows in the environment image were represented in the three-dimensional environment model 201.

The three-dimensional environment model 201 also comprises a virtual camera, which is used to project the three-dimensional environment model onto a 2D image that can be rendered on the device's display.

The three-dimensional environment model 201 also comprises a product billboard 203 with the product image 202 projected as a texture.

The product billboard 203 comprises a three-dimensional plane in the three-dimensional environment model 201.

The product billboard 203, also comprises a normal projection of the product image 202. The transparent sections of the product image 202 will make the product billboard's plane surface invisible making it appear like the object is part of the three-dimensional environment model.

The instruction icon 203 in FIG. 2A represents one of 12 possible instructions to the user. The 12 possible instructions are a positive and a negative direction for each of the 6 degrees of freedom of the device, namely, X rotation, Y rotation, Z rotation, X translation, Y translation and Z translation.

The said instructions are computed by a camera awareness engine, which is aware of the device's position and/or orientation in respect to the environment image and uses such information to direct the user towards a position and orientation that matches that of the virtual camera in respect to the three-dimensional environment model.

FIG. 2B shows the device 100 displaying on screen a situation resulting from the user responding to the instruction in the instruction icon 203 of FIG. 2A. It can be seen that the three-dimensional environment model 201 didn't change in respect to FIG. 2A but the environment image panned to the right in respect to FIG. 2A, as the user moved left.

FIG. 2C shows the device 100 displaying on screen a situation resulting from the user responding to the instruction on the instruction icon 203 of FIG. 2B. In this case the user found a position, which matches that of the virtual camera causing the three-dimensional environment model and the real scene to be perfectly aligned. In this condition, the product billboard 203 appears to be in the environment image.

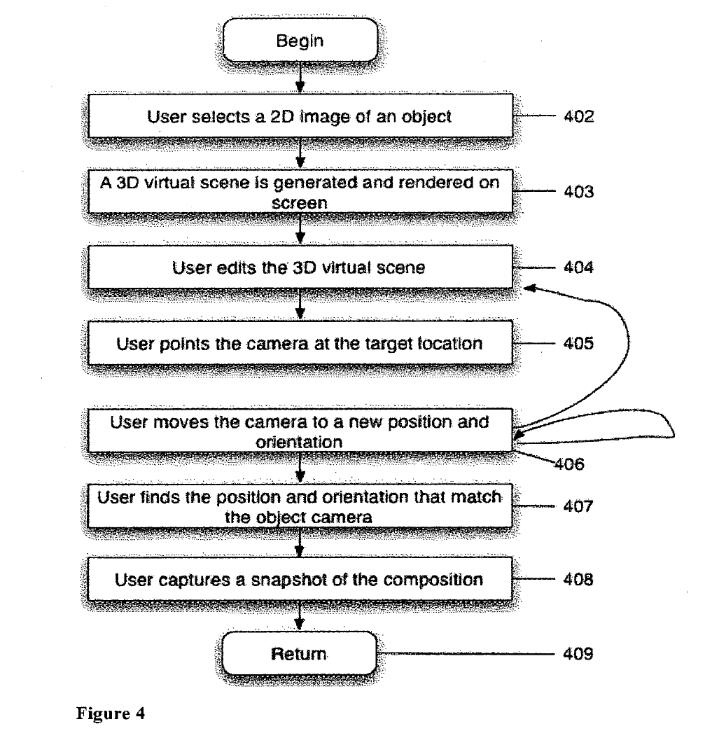

FIG. 4 shows a flow chart of a static embodiment of the present invention. In a static embodiment the system is not aware of the camera's position and/or orientation in respect to the environment image and therefore it can't instruct the user to move or rotate in the desired direction.

In a static embodiment the user is fully responsible of finding the position and orientation that would match the virtual camera.

In a static embodiment the user relies on intuition and understanding of perspective to find a position and orientation that would make the three-dimensional environment model and environment image align on screen in the way they do on FIG. 2C.

User edits three-dimensional environment model 404 on FIG. 4 represents an interaction mode in which the user can edit certain properties of the three-dimensional environment model in order to make it represent as close a possible the environment image. In said mode, the user also has the opportunity to determine the desired position and orientation of the object by moving the product billboard 203 in 3D space.

In FIG. 4 is shown the event of a user capturing a still snapshot 408 of the composition which will have removed the three-dimensional environment model except for the product billboard 203. This snapshot can be saved to persistent memory or sent and shared via a network connection or tether connection of the device to a personal computer. The snapshot is used by the user's enjoyment and to evaluate how the consumer product would look if purchased and placed on a particular location of their environment image.

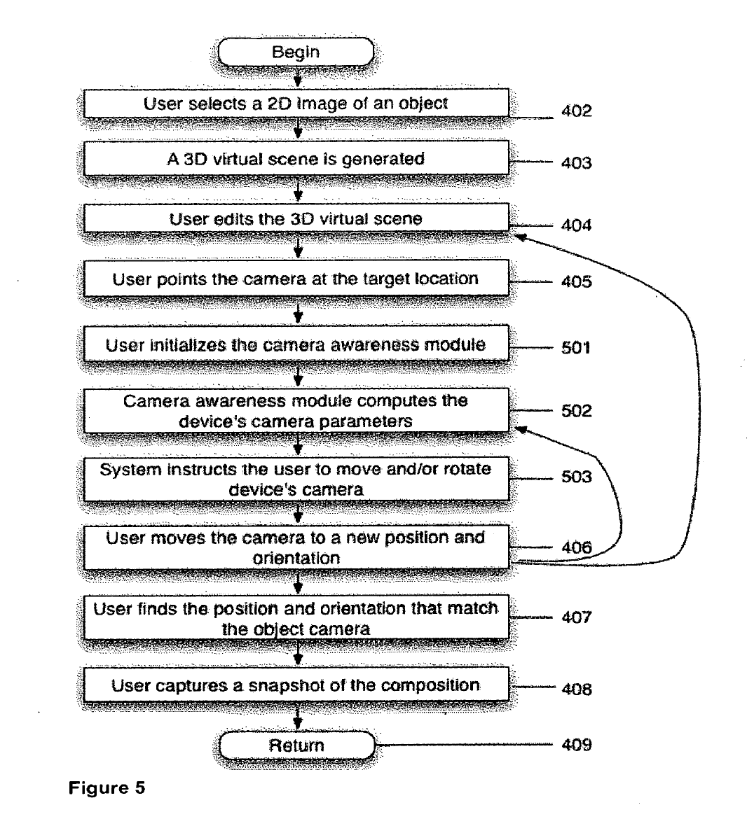

FIG. 5 shows a flow chart of a dynamic embodiment of the present invention. In a dynamic embodiment of the invention, the system comprises a camera awareness module, which deduces the device's camera position and/or orientation in respect to the environment. Using said information the system is able to instruct the user to move or rotate in a particular way.

In a dynamic embodiment of the present invention, there is a feedback loop between the user moving and rotating the camera 406, the camera awareness module computing the new camera position and/or orientation 502, and the instructions given by the system to the user 503.

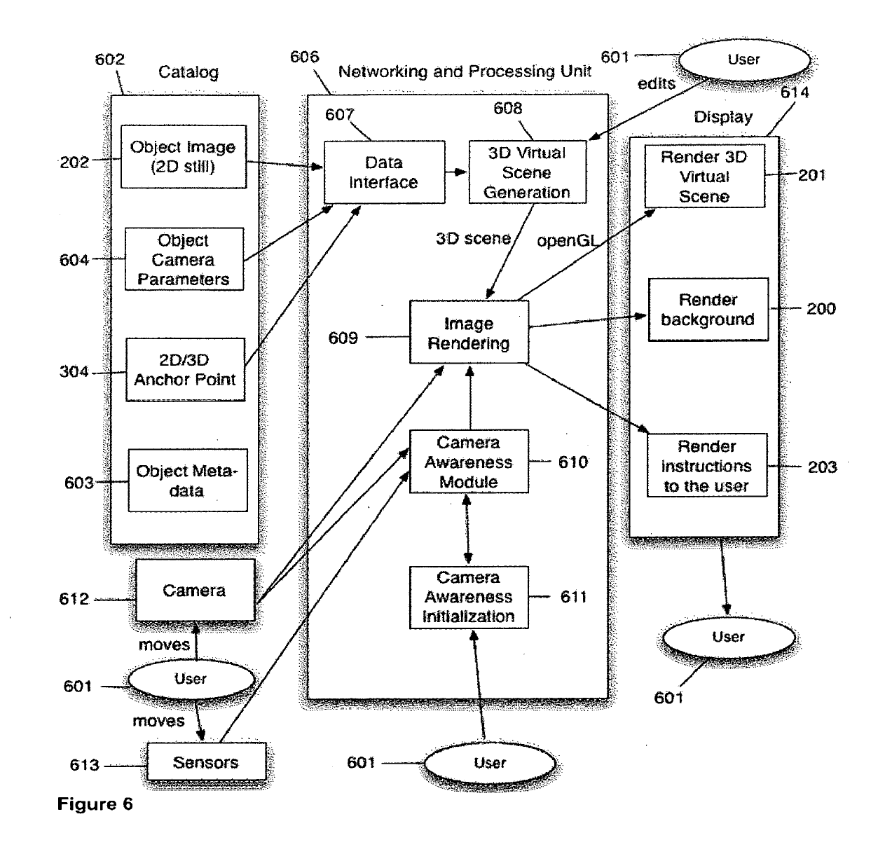

FIG. 6 is a flow chart showing the different components of the present invention.

In an embodiment of the present invention, a catalog 602 which can be remote and accessible by the hand-held augmented reality device via a network or can be local to the device's memory comprises sets of product images. A set of product images containing at least one product image 202 per product. The catalog 602 may also comprises of image data sets. Each of the image data sets comprises at least one product image set and its corresponding camera parameters 604. Optionally, the said image data set may comprise as well an anchor point 304 and meta-data 603 including real world product dimensions, common product configurations and any other available data pertaining the product.

Camera parameters 603 constitute a camera model, which describes the projection of a three-dimensional scene onto a two-dimensional image as seen by a real-world camera. There are multiple camera models used in the computer vision field, [Tsai87] being an example of a widely used one which comprises internal camera parameters:

f—Focal length of camera,

k—Radial lens distortion coefficient,

Cₒₓ, C_{y}—Co-ordinates of centre of radial lens distortion,

Sₓ—Scale factor to account for any uncertainty due to imperfections in hardware timing for scanning and digitization,

And external camera parameters:

Rₓ, R_{ye}, R_{z}—Rotation angles for the transformation between the world and camera co-ordinates,

Tₓ, T_{y}, T_{z}—Translation components for the transformation between the world and camera co-ordinates.

In the context of the present invention camera parameters 604 associated with the product image 603 are provided by the photographer of the product image or are extracted from the product image via a camera calibration process.

Still in reference to FIG. 6, the network and processing unit 606 refers to the software components which are assumed to execute on a typical programmable processing unit with it's associated memories, buses, network specific hardware and graphics processing unit.

In more detail, still referring to invention in FIG. 6, a data interface module 607 is responsible for accessing the data in the catalog 602 and making it available to the other software modules. The data interface 607 may comprise networking specific code to access a remote catalog and/or local file management code to access locally available data.

The data interface may implement a data caching mechanism in order to make recurring access to local or remote data more efficient.

Still referring to the invention in FIG. 6, the image-rendering unit 609 is associated with the display 614 and is, responsible for generating graphical primitive instructions that translate into visual elements on the hand-held augmented reality device's display screen. In more detail, the image rendering unit 609 takes the environment image from the camera, a three-dimensional environment model from the environment model generation unit 608 and an instruction from the camera awareness module 610 and generates one augmented image like the ones seen on FIG. 2 to be presented to the user.

Still referring to the invention in FIG. 6, the environment model generation unit 608 is responsible for generating a three-dimensional environment model 201, which represents a set of features from the environment image 200. The features represented by the three-dimensional environment model 201 are used, together with a representation of their counterparts in the environment image 200, by the user 601 and/or by the camera awareness module 610 to determine the device's camera discrepancy with the virtual camera.

In more detail, referring still to the environment model generation module 608, the virtual camera used to render the three-dimensional environment model is modeled after the object camera parameters 604. Initially, the product billboard 203 which is part of the three-dimensional environment model, is positioned and orientated in respect to the virtual camera such that when projected through the virtual camera it produces an image identical to the object image.

The rest of the three-dimensional environment model features, for instance, floor plane, wall planes, windows, etc, are positioned in respect to the product billboard and virtual camera in order to create the illusion, from the point of view of the virtual camera, of the object being in a plausible configuration within the three-dimensional environment model.

The object meta-data 603 is used by the environment model generation 608 to create an initial three-dimensional environment model, which has the object in a plausible configuration. For example, the object meta-data might specify that the object is commonly laying on the ground with its back face against a wall, which, for example, would be the case for a sofa. Said information about the product's configuration together with the product's real-world dimensions and the product's anchor point 304 is enough to generate a three-dimensional scene with a floor and a wall in which the object lays in a plausible configuration.

Still referring to the environment model generation unit 608 in FIG. 6, the user might be able to modify the three-dimensional environment model by repositioning its three-dimensional features.

Also, the user might be able to edit the scene by moving and scaling the object in respect to the device's screen. Moving the object in respect to the devices screen can be achieved via a rotation of the virtual camera, which doesn't affect the relative position of the camera in respect to the object.

Scaling the object in screen space can be achieved by changing the focal length of the virtual camera.

The object's relative scale in the three-dimensional environment model is well known from the object dimensions in the object meta-data 603.

The scale factor of the three-dimensional environment model in respect to the environment image needs to be roughly 1.0, for the object to appear of the correct scale in the final composition. There are multiple methods that can be used to get the user to provide a scale reference in the environment image. For example, a user can provide a distance between two walls or the width of a window in the three-dimensional environment model based on a measurement made on the environment image. Alternatively, a user can be instructed to position the camera at a certain distance from the wall against which the object will be positioned. Said distance can be computed based on the known focal length of the device's camera.

Referring to the camera awareness module 610 in FIG. 6, said module uses inputs from the camera and other sensors to deduce the position and/or orientation of the camera in respect to the environment image. Examples of types of inputs that could be used by different embodiments of the camera awareness module are: compass, accelerometer and the camera images themselves.

Using an accelerometer the camera awareness module 610 can detect gravity and deduce the vertical pitch of the camera.

Using a compass the camera awareness module 610 can deduce the horizontal orientation of the camera. Using computer vision algorithms like camera calibration and feature tracking from the video, the camera awareness module 610 can deduce, the internal camera parameters.

The camera awareness module can use some or all the available cues to make an estimation of the camera's position and/or orientation in respect to the environment image. The estimation generated by the camera awareness module is compared against the virtual camera in order to generate an instruction 203 for the user.

Referring to the camera awareness initialization module 611 in FIG. 6, the said module mostly implements an interaction mode where input is obtained from the user in order to initialize the camera awareness module 610.

Some of the cues used by the camera awareness module might require a reference value in order to be usable. For example, the compass will provide with an absolute orientation, however, the orientation of the environment image is unknown and therefore an absolute orientation alone is not sufficient to deduce the camera orientation in respect to the environment image. In the mentioned example, a user would point the camera in a direction perpendicular to the “main” wall in the environment image and press a button to inform the camera awareness initialization module 611 of the absolute orientation of said wall.

In the case of the accelerometer sensing gravity, there is no need for an initialization step because gravity is constant in all familiar frames of reference.

In the case of computer vision algorithms applied to the camera's video, there are many different algorithms and techniques that can be used. In some of such techniques, a set of features in the three-dimensional environment model need to be matched with their counterparts in the environment image. After such initialization step, typically a feature-tracking algorithm keeps the correspondence persistent as the camera moves and turns. A camera calibration algorithm uses the correspondence information together with the 3d and 2d coordinates of the tracked features to estimate the camera parameters. Other camera calibration algorithms might not require an initialization phase by using a well know object as a marker, which is placed on the real-worlds scene and detected by the camera awareness module in the camera video images.

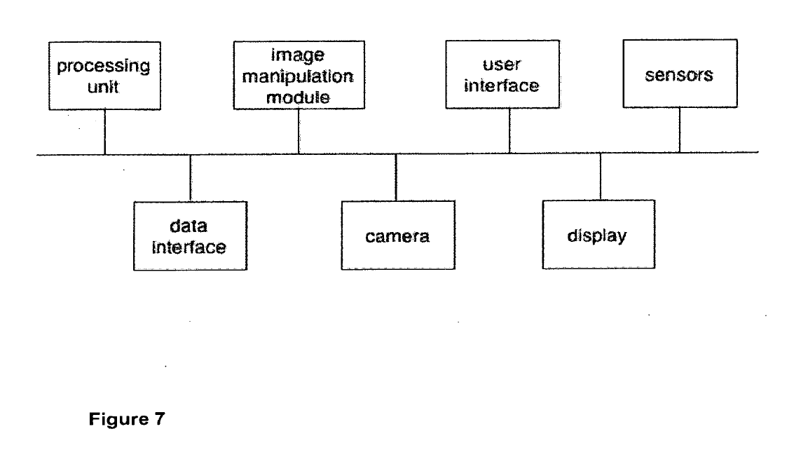

FIG. 7 shows a computer that may have a processing unit, data interface, image manipulation module, camera, user interface, display, and sensors connected by a bus.

1. A method comprising:
receiving in a hand-held augmented reality device a set of product images from an online database;
isolating the consumer product from the background in a product image;
capturing an environment image using a camera of the hand-held augmented reality device;
selecting the product image that better matches a desired perspective;
synthesizing an augmented image with product images embedded in the environment image using the processing unit of the hand-held augmented reality device;
displaying the augmented image in real-time on a display of the hand-held augmented reality device;
allowing a user to manually position the product image within the augmented image;
allowing the user to manually re-size the product image within the augmented image; and
allowing the user to manually orient the product image about a normal axis a plane of the image within the augmented image.

2. The method in claim 1 further comprising:
rendering the augmented image by projecting a product billboard onto an environment image;

3. The method in claim 2 further comprising:
allowing the user to manually orient a product billboard by specifying the product billboard's rotation in 3 cartesian axes;
allowing the user to manually position a product billboard by specifying the product billboard's position in 3 cartesian axes; and
allowing the user to manually re-size a product billboard by specifying the product billboard's dimensions in cartesian axes.

4. The method in claim 1 further comprising:
allowing the user to specify a set of three-dimensional features that are used to construct a three-dimensional environment model;
allowing the user to align the three-dimensional features of the three-dimensional environment model with an environment image;
employing sensor data to determine position and or altitude of the device's camera in respect to the device's camera's environment;
registering the three-dimensional environment model with the environment image

5. The method in claim 4 further comprising:
receiving a consumer product's description;
constructing an approximate three-dimensional product model from the description;
extracting the camera position and altitude of the camera used to photograph a consumer product from a product image;
automatically select a product image that best matches a desired perspective;
rendering the augmented image by projecting a product billboard created from the selected product image onto an environment image;
allowing the user to specify the location and orientation of a three-dimensional product model within a three-dimensional environment model;
automatically determining the position and orientation of the product billboard so that the product billboard's best represents visually the three-dimensional product model;
automatically determining the scale of the product billboard so that the product billboard's scale in respect to the environment image reflects the absolute scale of the real-world product and the user defined placement of the product model within the three-dimensional environment model;

6. The method in claim 2 further comprising:
allowing the user to specify an initial scale and orientation of the product billboard employing sensor data to determine altitude changes on the device's camera;
automatically adjusting the placement and orientation of the product billboard in order to keep the product billboard registered with a changing environment image

7. A hand-held computing device comprising:
a data interface receiving a set of product images from an online database;
an imaging manipulation module isolating the consumer product from the background in a product image;
a camera capturing an environment image;
the user interface for selecting a product image that better matches a desired perspective;
a processing unit for synthesizing an augmented image with the product image embedded in the environment image using a processing unit;
a display to show the augmented image in real-time; and
wherein the user interface for allowing the user to manually position the product image within the augmented image, to re-size the product image within the augmented image, and to manually orient the product image about the image plane's normal axis within the augmented image.

8. The hand-held computing device of claim 7 wherein the display for displaying the augmented image by projecting a product billboard onto an environment image;

9. The hand-held computing device of claim 8 wherein the user interface allows the user to manually orient a product billboard by specifying the product billboard's rotation in 3 cartesian axes, manually position a product billboard by specifying the product billboard's position in 3 cartesian axes; and manually re-size a product billboard by specifying the product billboard's dimensions in cartesian axes.

10. The hand-held computing device of claim 7 further comprising:
sensors to determine position and or altitude of the device's camera in respect to the device's camera's environment.

11. The hand-held computing device of claim 10, wherein
the user interface allows the user to specify a set of three-dimensional features that are used to construct a three-dimensional environment model and to align the three-dimensional features of the three-dimensional environment model with an environment image; and
the processing unit to register the three-dimensional environment model with the environment image.

12. The hand-held computing device of claim 10, wherein
the data interface receives a consumer product's description;
the processing unit constructs an approximate three-dimensional product model from the description and automatically selects a product image that best matches a desired perspective;
the display renders the augmented image by projecting a product billboard created from the selected product image onto an environment image;
the user interface allows the user to specify the location and orientation of a three-dimensional product model within a three-dimensional environment model; and
the processing unit automatically determines the position and orientation of the product billboard so that the product billboard best represents visually the three-dimensional product model and determines the scale of the product billboard so that the product billboard's scale in respect to the environment image reflects the absolute scale of the real-world product and the user defined placement of the product model within the three-dimensional environment model.

13. The hand-held computing device of claim 10, wherein:
the user interface allows the user to specify an initial scale and orientation of the product billboard; and
the processing unit automatically adjusts the placement and orientation of the product billboard in order to keep the product billboard registered with a changing environment image

14. A tangible machine-readable medium having a set of instructions detailing a method stored thereon that when executed by one or more processors cause the one or more processors to perform the method, the method comprising:
receiving in a hand-held augmented reality device a set of product images from an online database;
isolating the consumer product from the background in a product image;
capturing an environment image using a camera of the hand-held augmented reality device;
selecting a product image that better matches a desired perspective;
synthesizing an augmented image with product images embedded in the environment image using the processing unit of the hand-held augmented reality device;
displaying the augmented image in real-time on a display of the hand-held augmented reality device;
allowing a user to manually position the product image within the augmented image;
allowing the user to manually re-size the product image within the augmented image; and
allowing the user to manually orient the product image about a normal axis a plane of the image within the augmented image.

15. The tangible machine-readable medium of claim 14, further comprising:
rendering the augmented image by projecting a product billboard onto an environment image;

16. The tangible machine-readable medium of claim 15, further comprising:
allowing the user to manually orient a product billboard by specifying the product billboard's rotation in 3 cartesian axes;
allowing the user to manually position a product billboard by specifying the product billboard's position in 3 cartesian axes; and
allowing the user to manually re-size a product billboard by specifying the product billboard's dimensions in cartesian axes.

17. The tangible machine-readable medium of claim 14, further comprising:
allowing the user to specify a set of three-dimensional features that are used to construct a three-dimensional environment model;
allowing the user to align the three-dimensional features of the three-dimensional environment model with an environment image;
employing sensor data to determine position and or altitude of the device's camera in respect to the device's camera's environment;
registering the three-dimensional environment model with the environment image

18. The tangible machine-readable medium of claim 17, further comprising:
receiving a consumer product's description;
constructing an approximate three-dimensional product model from the description;
extracting the camera position and altitude of the camera used to photograph a consumer product from a product image;
automatically select a product image that best matches a desired perspective;
rendering the augmented image by projecting a product billboard created from the selected product image onto an environment image;
allowing the user to specify the location and orientation of a three-dimensional product model within a three-dimensional environment model;
automatically determining the position and orientation of the product billboard so that the product billboard's best represents visually the three-dimensional product model;
automatically determining the scale of the product billboard so that the product billboard's scale in respect to the environment image reflects the absolute scale of the real-world product and the user defined placement of the product model within the three-dimensional environment model;

19. The tangible machine-readable medium of claim 15, further comprising:
allowing the user to specify an initial scale and orientation of the product billboard employing sensor data to determine altitude changes on the device's camera;
automatically adjusting the placement and orientation of the product billboard in order to keep the product billboard registered with a changing environment image
